(19) United States
(12) Patent Application Publication
(10) Pub. No.: US 2002/0094833 A1
(43) Pub. Date: Jul. 18, 2002

(54) Downlink power control of a common transport channel

(75) Inventors: Gert-Jan Van Lieshout, Apeldoorn (NL); Goran Rune, Linkoping (SE); Magnus Persson, Sollentuna (SE)

Correspondence Address: NIXON & VANDERHYE P.C., 8th Floor, 1100 North Glebe Road, Arlington, VA, 22201, US

(73) Assignee: Telefonaktiebolaget LM Ericsson (publ).

(21) Appl. No.: 09/989,105

(22) Filed: Nov. 21, 2001

Related U.S. Application Data
(60) Provisional application No. 60/260,891, filed on Jan. 12, 2001.

(51) Int. Cl. H04B 1/00

(52) U.S. Cl. 455/522; 455/69

(57) ABSTRACT

A radio network control node that determines the transmit power of a common or shared downlink transport channel regulates that power based on one or more factors. The downlink transmit power regulation makes common downlink transport channel transmissions more efficient and effective in terms of delivering services to users, maximizing capacity, and reducing unnecessary interference. Examples of one or more factors that may be considered in regulating the transmit power on a common transport channel include (but are not limited to) include one or more measurements made by the user equipment of received downlink transmissions such as received signal strength, signal-to-interference ratio, error rates like bit error rate and block error, etc. Other potential factors could include current conditions in the cell such as traffic volume and percentage of maximum base station transmit power currently being used. The service(s) requested for each common transport channel user may also be taken into account. The controlling radio network node for the user connection uses one or more of these factors to adapt the downlink transmit power of the common transport channel. That power level adaptation may occur directly or indirectly via another radio network controller or base station node. The transmit power on the common transport channel may be regulated in general, per user connection, block-by-block, etc.

This application claims priority from the commonly-assigned provisional application entitled “Downlink Power Control of a Common Transport Channel,” application No. 60/260,891, filed on Jan. 12, 2001, the disclosure of which is incorporated herein by reference.

### FIELD OF THE INVENTION

The present invention relates to telecommunications, and particularly, to downlink power control over a common or shared transport channel.

### BACKGROUND AND SUMMARY OF THE INVENTION

In a typical cellular radio system, “wireless” user equipment units (UEs) and one or more “core” networks (like the public telephone network or Internet) communicate via a radio access network (RAN). The UEs very often are mobile, e.g., cellular telephones and laptops with mobile radio communication capabilities (mobile terminals). UEs and the core networks communicate both voice and data information via the radio access network.

The radio access network services a geographical area which is divided into cell areas, with each cell area being served by a base station (BS). Thus, a base station can serve one or multiple cells. A cell is a geographical area where radio coverage is provided by the radio base station equipment at a base station site. Each cell is identified by a unique identity, which is broadcast in the cell. Base stations communicate over a radio or “air” interface with the user equipment units. In the radio access network, one or more base stations are typically connected (e.g., by landlines or microwave links) to a radio network controller (RNC). The radio network controller, also sometimes termed a base station controller (BSC), supervises and coordinates various activities of its base stations. In turn, the radio network controllers are typically coupled together and coupled to one or more core network service nodes which interface with one or more core networks.

One example of a radio access network is the Universal Mobile Telecommunications System (UTMS) Terrestrial Radio Access Network (UTRAN). The UTRAN is a third generation system which in some respects builds upon the radio access technology known as Global System for Mobile communications (GSM) developed in Europe. UTRAN is a wideband code division multiple access (W-CDMA) system.

In W-CDMA technology, a common frequency band allows simultaneous communication between a user equipment unit and plural base stations. Signals occupying the common frequency band are discriminated at the receiving station through spread spectrum CDMA waveform properties based on the use of a high speed, pseudo-noise (PN) code. These high speed PN codes are used to modulate signals transmitted from the base stations and the user equipment units. Transmitter stations using different PN codes (or a PN code offset in time) produce signals that can be separately demodulated at a receiving station. The high speed PN modulation also allows the receiving station to advantageously generate a received signal from a single transmitting station by combining several distinct propagation paths of the transmitted signal. In CDMA, therefore, a user equipment unit need not switch frequency when handoff of a connection is made from one cell to another. As a result, a destination cell can support a connection to a user equipment unit at the same time the origination cell continues to service the connection. Since the user equipment is always communicating through at least one cell during handover, there is no disruption to the call. Hence, the term “soft handover.” In contrast to hard handover, soft handover is a “make-before-break” switching operation.

The UTRAN accommodates both circuit-switched and packet-switched connections. Circuit-switched connections involve a radio network controller communicating with a mobile switching center (MSC) node which in turn is connected to a connection-oriented, external core network like the Public Switched Telephone Network (PSTN) and/or the Integrated Services Digital Network (ISDN). Packet-switched connections involve the radio network controller communicating with a Serving GPRS Support Node (SGSN), which in turn is connected through a backbone network and a Gateway GPRS support node (GGSN) to packet-switched core networks like the Internet and X.25 external networks. There are several interfaces of interest in the UTRAN. The interface between the radio network controllers and the core network(s) is termed the “Iu” interface. The interface between two radio network controllers is termed the “Iur” interface. The interface between a radio network controller and its base stations is termed the “Iub” interface. The interface between the user equipment unit and the base stations is known as the “air interface” or the “radio interface.”

A goal of the Third Generation Partnership Project (3GPP) is to evolve further the UTRAN and GSM-based radio access network technologies. Of particular interest here is the support of variable transmission rate services in the third generation mobile radio communications system for both real time and non-real time services. Because users share the same radio resources, the radio access network must carefully allocate resources to individual UE connections based on quality of service requirements, such as variable rate services, and on the availability of radio resources.

When a core network desires to communicate with a UE, it requests services over the Iu interface from the radio access network in the form of radio access bearers (RABs) with a particular quality of service (QoS). Quality of service includes such things as data rates, speed, variability of data rate, amount and variability of delay, guaranteed versus best effort delivery, error rate, etc. A radio access bearer is a logical channel or connection through the UTRAN and over the radio interface which typically corresponds to a single data stream or flow. For example, in a multimedia session, one bearer may carry a speech connection, another bearer carries a video connection, and a third bearer may carry a packet data connection. Connections are mapped by the UTRAN onto physical transport channels. By providing radio access bearer services to the core network, the UTRAN isolates the core network from the details of radio resource handling, radio channel allocations, and radio control, e.g., soft handover. For simplicity, the term “connection” is used hereafter.

Between the UE and the UTRAN, a connection may be mapped to one or more dedicated transport channels (DCHs) or to a common transport channel such as a random access common channel (RACH), a forward access common channel (FACH), a common packet channel (CPCH), a downlink shared channel (DSCH), and a high speed-downlink shared channel (HS-DSCH). Real time connections are mapped to dedicated channels. On a dedicated channel, resources may be guaranteed to provide a particular service, such as a minimum transmission rate. For more information on transport channels in US, reference should be made to the UMTS 3GPP Specs as follows: 3G TS 25.211, V3.5.0; 3G TS 25.221,V3.5.0; and 3G TS 25.331, V3.5.0, the disclosures of which are incorporated herein by reference.

If during the lifetime of the connection, the UE moves to a cell controlled by another RNC, (referred to as a drift RNC (DRNC)), then the RNC that was initially set up to handle the connection for the UE, (referred to as the serving RNC (SRNC)), must request radio resources for the connection from the drift RNC over the Iur interface. If that request is granted, a transmission path is established for the connection between the SRNC and the DRNC to the UE through a base station controlled by the DRNC.

If the connection is mapped to a common transport channel, the drift RNC allocates the UE connection to a specific common transport channel, e.g., the FACH. Accordingly, information for the UE is transmitted on the established connection over the Iur interface from the serving RNC to the drift RNC. The drift RNC then schedules transmission on the common channel to the UE, taking into account the amount of data to be transmitted on this common channel to other UEs as well. For example, the drift RNC may use a “credit-based” data packet flow control protocol over the Iur interface to limit the amount of data that needs to be buffered in the drift RNC. Thus, the drift RNC, which performs admission control in the cell in which the UE is currently located, also controls the data transmission rate or throughput in that cell.

Wile there have been efforts to regulate the downlink transmit power of dedicated transport channels, this is not the case with the downlink transmit power of common or shared transport channels shared by two or more users. Common transport channels have been assumed to utilize only a small percentage of the base station's total downlink transmit power. Therefore, the conventional thinking is there is no need or advantage to regulating the transmit power of downlink common transport channels. Accordingly, transmissions over such downlink common transport channels are conducted at predetermined, fixed settings for each user transmission. Typically, that fixed preset power level is set at a maximum power level to cover “worst case” scenarios. However, this kind of “don't care” and rigid approach results in inefficient allocation of limited radio resources and often generates unnecessary levels of interference. Both reduce capacity, performance, and ultimately, the quality of service provided to users.

The present invention recognizes and overcomes these drawbacks. The radio network control node that sets the transmit power of a downlink transport channel regulates that power based on one or more factors. Such downlink transmit power regulation makes downlink common transport channel transmissions more efficient and effective in terms of delivering services to users, maximizing capacity, and reducing unnecessary interference. Examples of one or more factors that may be considered in regulating the transmit power on a common transport channel include (but are not limited to) include one or more measurements made by the user equipment of received downlink transmissions such as received signal strength, signal-to-interference ratio, error rates like bit error rate and block error, etc. Other potential factors could include current conditions in the cell such as traffic volume and percentage of maximum base station transmit power currently being used. The service(s) requested for each common transport channel user may also be taken into account.

The controlling radio network node for the user connection uses one or more of these factors to adapt the downlink transmit power of the common transport channel. That power level adaptation may occur directly or indirectly via another radio network controller or base station node. The transmit power on the common transport channel may be regulated in general, per user connection, block-by-block, etc.

While the present invention may be utilized when a single radio network control node supports a user connection in the radio network, it may also be applied to plural supporting radio network control nodes. In am example, non-limiting implementation described further below, a serving RNC is able to adjust the downlink transmit power of a common transport channel, such as a FACH channel, by sending power adjustment information to the drift RNC for that user connection. That power adjustment information may be communicated between the SRNC and the DRNC in any fashion. Examples include in the common transport channel data frame, e.g., FACH data frame, or in a signaling message, e.g., in RNSAP protocol signaling.

### BRIEF DESCRIPTION OF THE DRAWINGS

The foregoing and other objects, features, and advantages of the present invention may be more readily understood with reference to the following description taken in conjunction with the accompanying drawings.

FIG. 1 is a function block diagram illustrating an example mobile radio communications system in which the present invention may be employed;

FIG. 2 illustrates establishing a connection from a core network to a user equipment unit though a serving RNC;

FIG. 3 illustrates a situation where, because of movement of the user equipment, the connection is supported by both a serving RNC and a drift RNC;

FIG. 4 is a flowchart diagram illustrating common transport channel power control procedures in accordance with a first example embodiment of the present invention;

FIG. 5 is a flowchart diagram illustrating a second example embodiment of common transport channel power control as applied to a user connection supported by both a serving RNC and a drift RNC;

FIG. 6 is a diagram illustrating various signals communicated between the SRNC, DRNC, and UE in the second example embodiment of the present invention; and

FIG. 7 is an example FACH data frame in which FACH power control information is communicated.

### DETAILED DESCRIPTION OF THE INVENTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details. For example, while the present invention is described in the downlink power control of a forward access channel (FACH), the present invention may be applied for power control of any downlink common transport channel.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

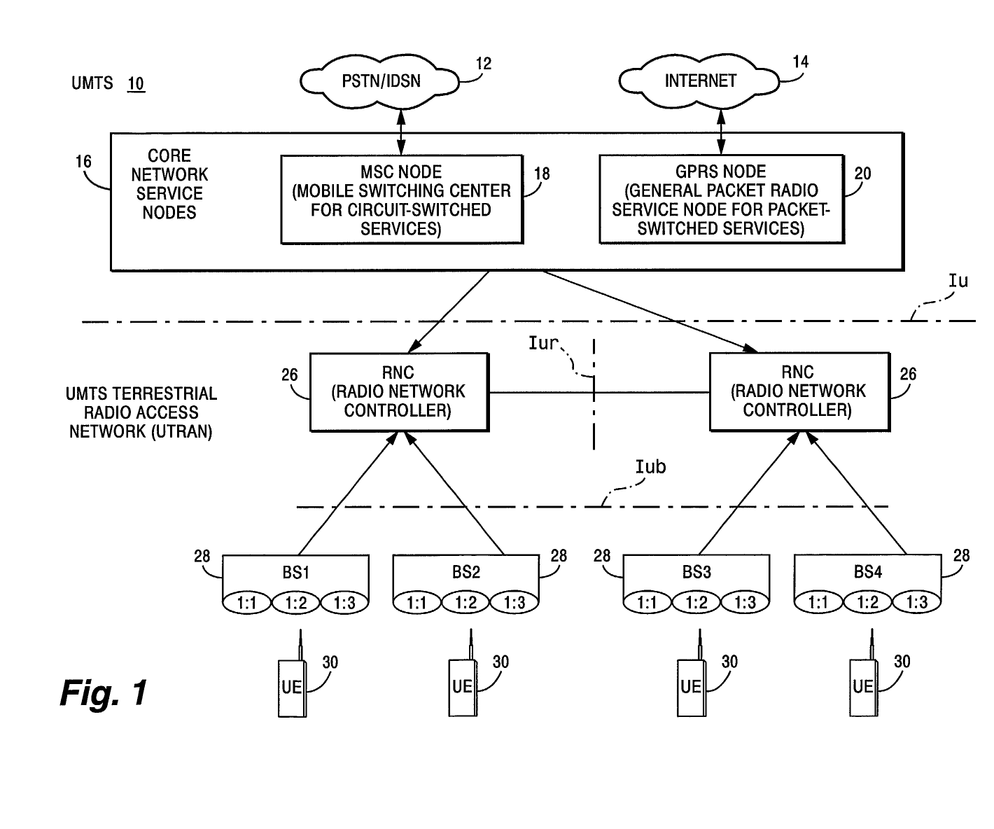

The present invention is described in the non-limiting, example context of a Universal Mobile Telecommunications System (UMTS) 10 shown in FIG. 1. A representative, connection-oriented, external core network, shown as a cloud 12 may be, for example, the Public Switched Telephone Network (PSTN) and/or the Integrated Services Digital Network (ISDN). A representative, connectionless-oriented external core network shown as a cloud 14, may be for example the Internet. Both core networks are coupled to corresponding core network service nodes 16. The PSTN/ISDN network 12 is connected to a connection-oriented service node shown as a Mobile Switching Center (MSC) node 1 that provides circuit-switched services. The Internet network 14 is connected to a General Packet Radio Service (GPRS) node 20 tailored to provide packet-switched type services which is sometimes referred to as the serving GPRS service node (SGSN).

Each of the core network service nodes 18 and 20 communicate with a UMTS Terrestrial Radio Access Network (UTRAN) 24 over a radio access network (RAN) interface referred to as the Iu interface. UTRAN 24 includes one or more radio network controllers (RNCs) 26. For sake of simplicity, the UTRAN 24 of FIG. 1 is shown with only two RNC nodes. Each RNC 26 communicates with a plurality of base stations (BS) 28 BS1-BS4 over the Iub interface. For example, and again for sake of simplicity, two base station nodes are shown connected to each RNC 26. It will be appreciated that a different number of base stations can be served by each RNC, and that RNCs need not serve the same number of base stations. Moreover, FIG. 1 shows that an RNC can be communicated over an Iur interface to one or more RNCs in the URAN 24. A user equipment unit (UE), such as a user equipment unit (UE) 30 shown in FIG. 1, communicates with one or more base stations (BS) 28 over a radio or air interface 32. Each of the radio interface 32, the Iu interface, the Iub interface, and the Iur interface are shown by dash-dotted lines in FIG. 1.

Preferably, radio access is based upon Wideband Code Division Multiple Access (WCDMA) with individual radio channels allocated using CDMA spreading codes. Of course, other access methods may be employed. WCDMA provides wide bandwidth for multimedia services and other high transmission rate demands as well as robust features like diversity handoff and RAKE receivers to ensure high quality. Each user mobile station or equipment unit (UE) 30 is assigned its own scrambling code in order for a base station 28 to identify transmissions from that particular user equipment as well as for the user equipment to identify transmissions from the base station intended for that user equipment from all of the other transmissions and noise present in the same area.

Different types of control channels may exist between one of the base stations 28 and user equipment units 30. For example, in the forward or downlink direction, there are several types of broadcast channels including a general broadcast channel (BCH), a paging channel (PCH), a common pilot channel (CPICH), and a forward access channel (FACH) for providing various other types of control messages to user equipment units. In the reverse or uplink direction, a random access channel (RACH) is employed by user equipment units whenever access is desired to perform location registration, call origination, page response, and other types of access operations. The random access channel (RACH) and forward access channel (FACH) are also used for carrying certain user data, e.g., small amounts of best effort packet data. In both directions, dedicated transport channels (DCH) may be allocated to carry real time traffic or a substantial amount of non-real time data traffic for a specific user equipment (UE) unit. The present invention is particularly concerned with any type of transport channel that carries traffic to the UE that does not employ power control. Typically, but not necessarily, such transport channels are common or shared channels. Other non-limiting examples of channels that may use the invention include a downlink shared channel (DSCH), high speed-downlink shared channel (HS-DSCH), high speed data packet access (HSDPA), etc.

With respect to a certain RAN-UE connection, an RNC can have the role of a serving RNC (SRNC) or the role of a drift RNC (DRNC). If an RNC is a serving RNC, the RNC is in charge of the connection with the user equipment unit and has full control of the connection within the radio access network (RAN). A serving RNC interfaces with the core network for the connection. On the other hand, if an RNC is a drift RNC, it supports the serving RNC by supplying radio resources (within the cells controlled by the drift RNC) needed for a connection with the user equipment.

When a connection between the radio access network and user equipment is being established, the RNC that controls the cell where the user equipment (UE) is located when the connection is established is the serving RNC. As the user equipment moves, the connection is maintained by establishing radio communication branches or legs, often called “radio links,” via new cells, which may be controlled by other RNCs. Those other RNCs become drift RNCs for the connection.

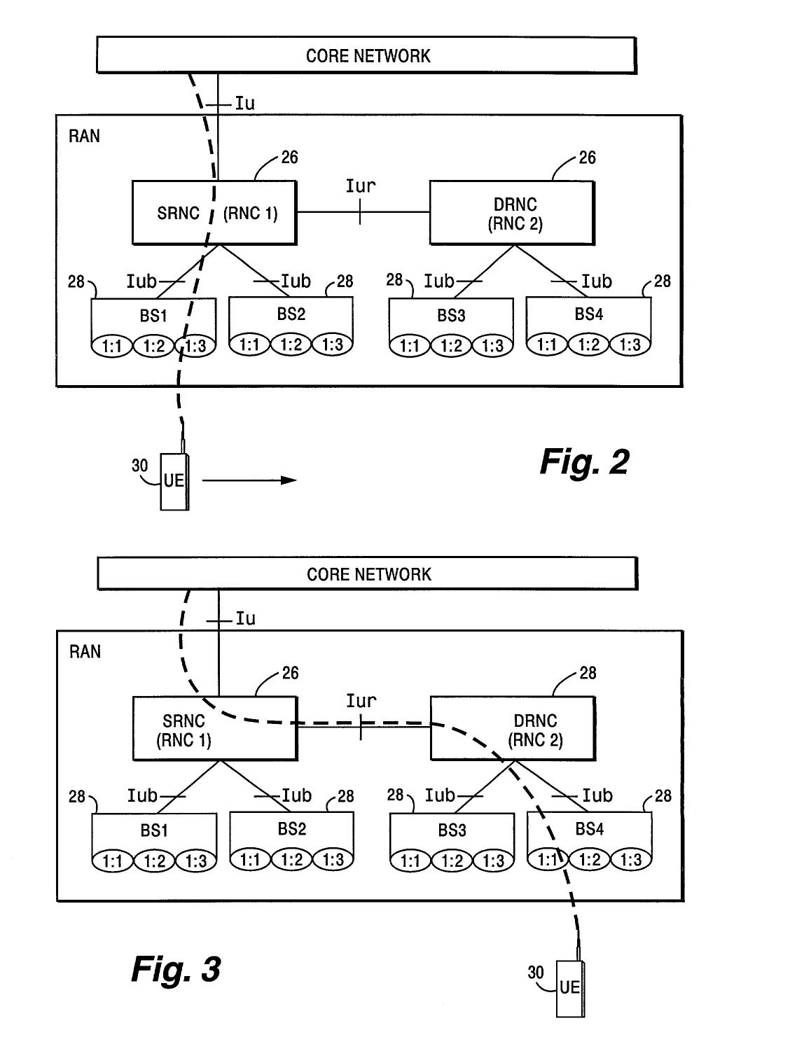

To illustrate the foregoing, and as a prelude to an explanation of the present invention, reference is made to the situation shown in FIG. 2. FIG. 2 shows an example of RNC role assignment for user equipment 30 at initial setup of a connection involving user equipment 30. In FIG. 2, radio network controller RNC1 26 acts as the serving RNC for the connection with user equipment 30, located in cell 3 controlled by base station BS1. The connection with user equipment 30 in FIG. 2 is shown by a broken line which extends from core network 16, through radio network controller RNC1, base station BS1, and a BS1's cell 3 to user equipment 30.

Suppose that user equipment 30 travels to the right as indicated by an arrow in FIG. 2, eventually leaving the cell 3 controlled by base station BS1 and traveling successively through the cells controlled by respective base stations BS2 and BS3. As user equipment unit 30 enters a new cell, a handover occurs. FIG. 3 shows user equipment 30 arriving at the cell 1 controlled by base station BS4. Radio network controller 1 still acts as the serving RNC for the connection to user equipment 30, and radio network controller RNC2 acts as the drift RNC. In other words, serving RNC1 controls the connection with user equipment 30, while drift RNC2 supplies resources for the connection with respect to cell 1. The connection is again shown by the broken line.

As described above, when a UE moves to cells controlled by a drift RNC, the serving RNC needs to request resources for this UE from the drift RNC over the Iur interface. The drift RNC allocates certain types of resources for the cell in question such as interference and power resources. The drift RNC also requests the appropriate radio base station to allocate resources internal to the base station needed to support the connection.

The above description of FIGS. 1-3 sets forth example (non-limiting) applications for the downlink power control of common or shared transport channels. One non-limiting example of a downlink common transport channel is a FACH transport channel. (As already explained, the present invention may be used with any channel that does not use power control). Rather than having a radio network controller or a base station select a fixed transmit power for the downlink common transport channel, e.g., a maximum transmit power level, for all transmissions at all times over that common transport channel, the present invention utilizes an adaptive downlink power setting approach for common transport channels.

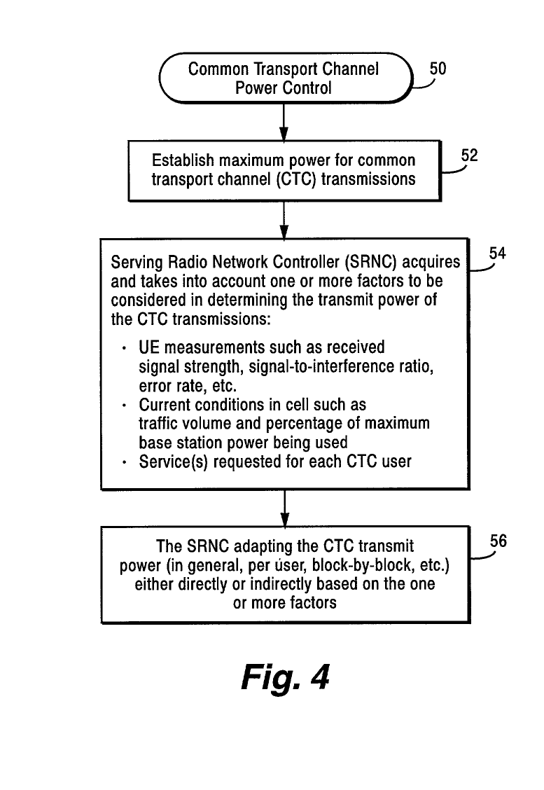

A flowchart illustrating example procedures for implementing this common transport channel power control (block 50) is now described in conjunction with FIG. 4. This common transport channel power control routine may be employed in the situation shown in FIG. 2 where a user connection is being supported by a single RNC as well as a situation illustrated in FIG. 3 where the user connection is supported by a serving RNC and a drift RNC.

The serving RNC acquires and takes into account one or more factors to be considered in determining the transmit power of the common transport channel transmissions. For example, the SRNC takes into account one or more user equipment (UE) measurements made by UE 30 such as received signal strength, signal-to-interference ratio (SIR), bit error rate (BER), block error rate (BLER), etc. of a recently received downlink transmission over the common transport channel. Other factors may also be considered by the serving RNC, including current conditions in the cell (and surrounding cells) like traffic volume, interference level, and percentage of maximum base station power being used. Another optional factor is to take into account one or more services requested or being used by each UE communicating over the common transport channel (block 54).

The serving RNC adapts the downlink transmit power from the base station over the common transport channel, either directly (as in FIG. 2), or indirectly byway of the drift RNC (as in FIG. 3), based on the one or more factors, examples of which are outlined above. The adaptation of the transmit power may be implemented in general for the entire common transport channel, for each user connection on that channel, or for each block or time slot, i.e., block-by-block. The last two options give greater flexibility in setting the transmit power in a fashion that is appropriate for each UE connection in light of current conditions and services.

If UE measurements are employed, a weaker signal strength, a lower SIR, or a higher error rate suggest that the SRNC increase the transmit power (if possible). Conversely, a high received signal strength, high SIR, or low error rate suggest that the SRNC indicate a lower transmit power, if otherwise desirable. Current conditions in the cell, and possibly surrounding cells, such as interference level and traffic volume, may also be taken into account. Higher traffic volumes and higher interference levels may suggest that lower transmit power values be used, assuming that minimum service levels are still satisfied.

Another factor is percentage of maximum base station power currently being utilized. If the base station is transmitting near maximum, the SRNC may elect not to increase the downlink transmit power over the common transport channel even though other factors such as UE measurements might suggest an increase. Alternatively, if the base station is transmitting well under its maximum level, the SRNC may decide to increase the downlink transmit power level for the common transport channel in general to improve service. Certain services requested by each UE might also be used. Higher priority services might indicate increased power levels, and lower priority services, lower power levels.

The present invention is particularly advantageous in the SRNC-DRNC configuration shown in FIG. 3. The DRNC, which sets the transmit power of the base station, is typically uninformed about the types of factors outlined in block 54 in FIG. 4. In other words, the drift RNC often performs a data transfer operation without decoding and analyzing the content of the data being transferred. In the present invention, the SRNC, which does decode and analyze the content of the communications over the UE connection, provides “intelligence” for a power regulation scheme controlled at the DRNC. Even if the DRNC were to be “intelligent” and regulate the transmit power of the common transport channel in some fashion based on parameters locally available to the DRNC, it still may be useful to receive power adjustment information acquired at and provided from the SRNC.

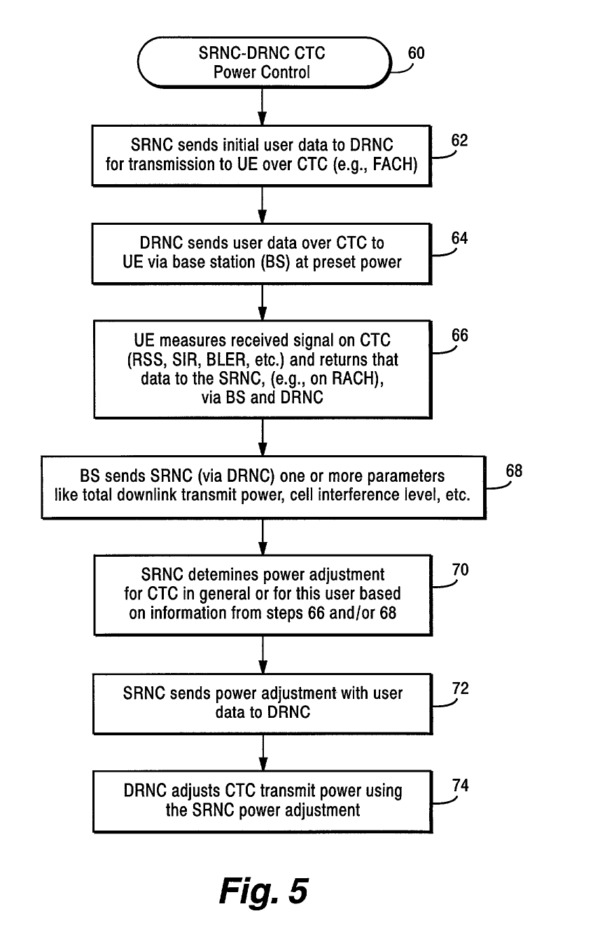

Reference is now made to the SRNC-DRNC common transport channel power control routine (block 60) set forth in flowchart format in FIG. 5. The SRNC sends initial user data for a UE connection to the DRNC for transmission to the UE over the common transport channel, e.g., the FACH channel (block 62). The DRNC sends the user data over the common transport channel to the UE via the base station at a preset transmit power level (initially) (block 64). Alternatively, the SRNC could send specific information regarding the initial transmit power based on conditions in the cell, current base station total transmit power level, etc. The user equipment (UE) measures received signals on the common transport channel to formulate certain parameters such as received signal strength (RSS), signal-to-interference ratio (SIR), block error rate (BLER), etc. The UE could also measure information on other downlink channels such as pilot signals transmitted by each base station.

The UE measurement information is returned to the SRNC via the base station and DRNC, e.g., on the RACH channel (block 66). The base station also sends the SRNC (via the DRNC) one or more parameters like total downlink transmit power, cell interference level, etc. (block 68). The SRNC determines power adjustment for the common transport channel (1) in general, (2) for this user, or (3) for each block on the common transport channel, based on any of the information acquired in steps 66 and/or 68 (block 70). The SRNC sends a power adjustment with the user data (DRNC) (block 72). The DRNC adjusts the transmit power of the downlink common transport channel using the SRNC power adjustment value (block 74).

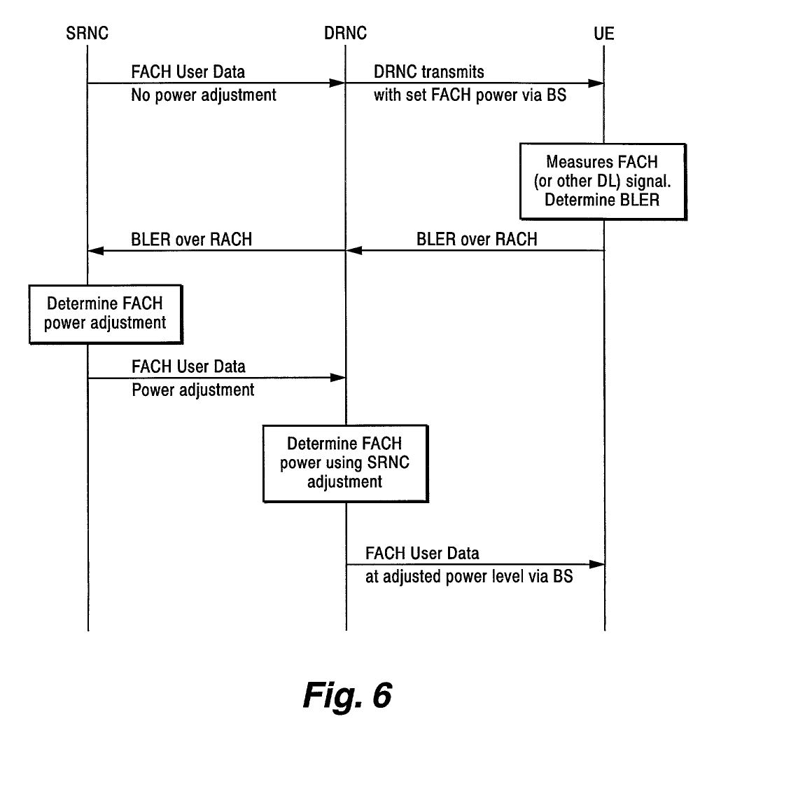

An example signaling diagram is illustrated in FIG. 6 for the SRNC-DRNC common transport channel power control described in conjunction with FIG. 5. The FACH channel is used as a non-limiting example of a common transport channel, and block error rate is used as a non-limiting example power control parameter. Other types of transport channels and power control parameters may be employed. The SRNC sends the initial FACH user data (with or without the power adjustment value) to the DRNC. The DRNC transmits that user data using the FACH power level set at the base station (or if an initial power level is sent by the SRNC using that initial power level). The UE measures FACH or other downlink signal information to determine a block error rate (BLER). The block error rate is transmitted from the UE over the RACH channel to the DRNC, which forwards the BLER to the SRNC.

From the block error rate information provided by the UE, the SRNC determines a FACH power adjustment and sends that adjustment along with the next block of FACH user data to the DRNC. The power information could be an incremental power increase or decrease amount (e.g., +1 dB or −1 dB), or an absolute power level setting. Moreover, and as stated above, the power correction may be superimposed on any power change that the DRNC already has decided upon based on local information. In any event, the DRNC determines the FACH power level using that SRNC power adjustment information. The FACH user data is transmitted via the base station at the adjusted power level.

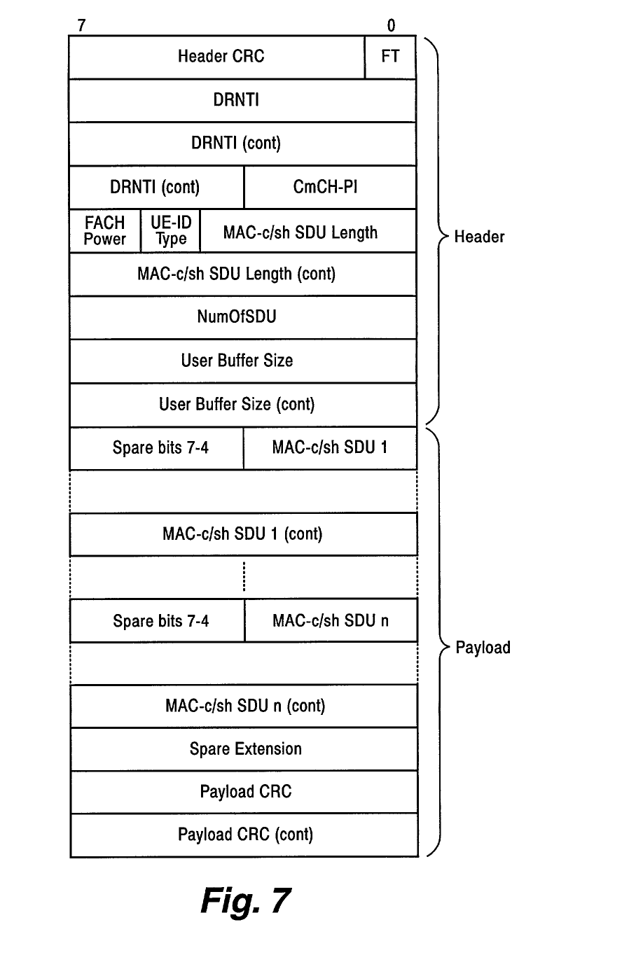

These power corrections determined by the SRNC may be signaled to the DRNC in a number of different ways. One way to perform this efficiently and quickly is to use existing data structures or existing signal protocols. For the FACH, one example of an existing FACH data frame structure is shown in FIG. 7. The FACH power information is included in a spare bits field in the header. Another approach is to transfer a power offset table which includes power offsets for all FACH UE connections. Such a table could be transferred using control signaling (rather than using data frames) between the SRNC and the DRNC. One such signaling protocol where this could be done is the RNSAP protocol. A disadvantage of this approach, however, is that it is somewhat slower than the data frame transfer since the RNSAP signaling cannot be used as frequently as, and is not synchronized to the data like, a data frame protocol. More information regarding the FACH data frame and the RNSAP signaling protocol may be obtained from the 3G TS 25.425, v.3.3.0: UTRAN Iur Interface user plane protocols for CCH data streams and the 3G TS 25.423, v3.4.0: UTRAN Iur Interface RNSAP Signaling.

Accordingly, any information that the SRNC can obtain, and which is relevant for setting downlink power on common transport channels, can be used to adjust the downlink power setting performed by the drift RNC. This improves the performance of the common transport channel, and as a result, improves the overall system capacity and stability. In addition, any channel type switching, e.g., between a dedicated channel and a common channel, may be improved using the present invention.

While the present invention has been described with respect to particular example embodiments, those skilled in the art will recognize that the present invention is not limited to those specific embodiments described and illustrated herein. Again, the present invention is not limited to a particular common or shared transport channel. Indeed, the present invention may be used to perform power control on any channel that does not already employ some sort of power control. Different formats, embodiments, adaptations besides those shown and described, as well as many modifications, variations and equivalent arrangements may also be used to implement the invention. Accordingly, it is intended that the invention be limited only by the scope of the claims appended hereto.

What is claimed is:

1. A method for use in a radio network including a radio network node coupled to a base station transmitting information over a radio interface on a common transport channel shared by plural mobile stations, a method comprising:
determining one or more conditions relating to a transmit power level for transmitting information over the radio interface to a mobile station using the common transport channel, and
regulating the transmit power level on the common transport channel based on the determined one or more conditions.

2. The method in claim 1, wherein the one or more conditions includes measurement information relating to a signal received by the mobile station.

3. The method in claim 2, wherein the measurement information includes received signal strength information.

4. The method in claim 2, wherein the measurement information includes received signal-to-interference information.

5. The method in claim 2, wherein the measurement information includes error rate information.

6. The method in claim 2, wherein the signal is on the common transport channel.

7. The method in claim 2, wherein the signal is on a downlink pilot channel.

8. The method in claim 1, wherein the one or more conditions includes information relating to a base station transmit power.

9. The method in claim 1, wherein the one or more conditions includes information relating to a service requested by the mobile station.

10. The method in claim 1, wherein the common transport channel is a forward access channel or a downlink shared channel.

11. The method in claim 1, wherein the common transport channel is a common packet channel or a high speed-downlink shared channel.

12. The method in claim 1, wherein the one or more conditions is analyzed in the radio network node.

13. The method in claim 1, wherein the radio network node uses power adjustment information to regulate the base station transmit power level on the common transport channel.

14. The method in claim 1, wherein the radio network node is a serving radio network controller which sends power adjustment information to a drift radio network controller which regulates the base station transmit power level on the common transport channel using the power adjustment information.

15. The method in claim 14, wherein the serving radio network controller determines an initial transmit power for the base station and sends that initial transmit power to the drift radio network controller.

16. The method in claim 14, wherein the drift radio network controller determines an initial transmit power for the base station.

17. The method in claim 14, wherein the serving radio network controller sends power adjustment information to the drift radio network controller as part of a data frame.

18. The method in claim 17, wherein the power adjustment information is sent a spare bits field of the data frame.

19. The method in claim 17, wherein the power adjustment information is sent as power offset information.

20. The method in claim 14, wherein the serving radio network controller sends power adjustment information to the drift radio network controller using a control signaling protocol.

21. The method in claim 1, wherein the regulating of the transmit power level is performed for the entire common transport channel.

22. The method in claim 1, wherein the regulating of the transmit power level is performed on the common transport channel on a per user connection basis.

23. The method in claim 1, wherein the regulating of the transmit power level is performed on a data block or time slot basis.

24. For use in a radio network including a radio network node coupled to a base station transmitting information over a radio interface on a common transport channel shared by plural mobile stations, the radio network node comprising:
a detector configured to detect one or more conditions relating to a transmit power level for transmitting information over the radio interface to a mobile station using the common transport channel, and
power control circuitry configured to determine power adjustment information for use in regulating a transmit power level on the common transport channel based on the detected one or more conditions.

25. The radio network node in claim 24, wherein the one or more conditions includes measurement information relating to a signal received by the mobile station.

26. The radio network node in claim 25, wherein the measurement information includes received signal strength information.

27. The radio network node in claim 25, wherein the measurement information includes received signal-to-interference information.

28. The radio network node in claim 25, wherein the measurement information includes error rate information.

29. The radio network node in claim 24, wherein the one or more conditions includes information relating to a base station downlink transmit power.

30. The radio network node in claim 24, wherein the one or more conditions includes information relating to a service requested by the mobile station.

31. The radio network node in claim 24, wherein the common transport channel is a forward access channel or a downlink shared channel.

32. The radio network node in claim 24, wherein the common transport channel is a common packet channel or a high speed downlink shared channel.

33. The radio network node in claim 24, wherein the radio network node is a serving radio network controller.

34. The radio network node in claim 33, wherein the serving radio network controller uses power adjustment information to regulate the base station transmit power level.

35. The radio network node in claim 33, wherein the serving radio network controller sends power adjustment information to a drift radio network controller which regulates the transmit power level at the base station using the power adjustment information.

36. The radio network node in claim 35, wherein the serving radio network controller sends power adjustment information to the drift radio network controller as part of a data frame.

37. The radio network node in claim 33, wherein the serving radio network controller sends power adjustment information to the drift radio network controller using a control signaling protocol.

38. The method in claim 24, wherein the regulating of the transmit power level is performed for the entire common transport channel.

39. The method in claim 24, wherein the regulating of the transmit power level is performed on the common transport channel on a per user connection basis.

40. The method in claim 24, wherein the regulating of the transmit power level is performed on a data block or time slot basis.

41. A radio network comprising:
a serving radio network controller (SRNC), responsive to an external network, for initially establishing a connection over a radio interface with a mobile station via a first base station supervised by the serving radio network controller;
a drift radio network controller (DRNC), coupled to the serving radio network controller, for supporting the connection from the serving radio network controller to the mobile station over a common transport radio channel after the connection is handed over to a second base station supervised by the drift radio network controller;
the SRNC determining one or more conditions that affect transmission of information from the second base station to the mobile station over the common transport channel, to determine power adjustment information based on the determined one or more conditions, and to provide the power adjustment information to the DRNC, and
the DRNC using the power adjustment information from the SRNC to regulate a transmit power level on the common transport channel.

42. The network in claim 41, wherein the one or more conditions includes measurement information relating to a signal received by the mobile station.

43. The network in claim 42, wherein the measurement information includes one of the following: received signal strength information, received signal-to-interference information, and error rate information.

44. The network in claim 41, wherein the serving radio network controller determines an initial transmit power for the second base station and sends that initial transmit power to the drift radio network controller.

45. The network in claim 41, wherein the drift radio network controller determines an initial transmit power for the second base station.

46. The network in claim 41, wherein the serving radio network controller sends power adjustment information to the drift radio network controller as part of a data frame.

47. The network in claim 41, wherein the power adjustment information is sent a spare bits field of the data frame.

48. The network in claim 41, wherein the power adjustment information is sent as power offset information.

49. The network in claim 41, wherein the serving radio network controller sends power adjustment information to the drift radio network controller using a control signaling protocol.

50. The network in claim 41, wherein the DRNC regulates the transmit power level for the entire common transport channel.

51. The network in claim 41, wherein the DRNC regulates the transmit power level on the common transport channel on a per user connection basis.

52. The network in claim 41, wherein the DRNC regulates the transmit power level on a data block or time slot basis.
